(19) United States
(12) Patent Application Publication
(10) Pub. No.: US 2019/0169892 A1
(43) Pub. Date: Jun. 6, 2019

(54) INSIDE HANDLE WITH INTEGRATED GRIP

(71) Applicants: Hyundai Motor Company, Seoul (KR); Kia Motors Corporation, Seoul (KR)

(72) Inventor: Chi Young MIN, Bucheon-si (KR)

(73) Assignees: Hyundai Motor Company, Seoul (KR); Kia Motors Corporation, Seoul (KR)

(21) Appl. No.: 15/983,591

(22) Filed: May 18, 2018

(30) Foreign Application Priority Data
Dec. 1, 2017 (KR) 10-2017-0164218

(51) Int. Cl. E05B 85/12; E05B 79/20; E05B 79/06

(52) U.S. Cl. CPC E05B 85/12; E05B 79/06; E05B 79/20

(57) ABSTRACT

An inside handle with integrated grip, may include a grip handle rotatably mounted on a door trim of a vehicle door and configured for being gripped, and a cable connector assembly having a lever which is pivotable by a rotation of the grip handle, wherein the lever moves a cable assembly connected to a latch mechanism of the vehicle door to lock or unlock the latch mechanism of the vehicle door.

### CROSS-REFERENCE TO RELATED APPLICATION

The present application claims priority to Korean Patent Application No. 10-2017-0164218, filed on Dec. 1, 2017, the entire contents of which is incorporated herein for all purposes by this reference.

### BACKGROUND OF THE INVENTION

### Field of the Invention

The present invention relates to an inside handle with integrated grip and, more particularly, to an inside handle with integrated grip, in which a grip and an inside handle are integrated to thereby improve ease of use, freedom of design, and aesthetic appearance.

### Description of Related Art

In general, a vehicle has a vehicle door designed to move between an opening position and a closed position to open or close an opening of a vehicle body, and the vehicle door is provided with a latch mechanism. Locking or unlocking the latch mechanism may fix the vehicle door to the closed position or release the vehicle door therefrom.

The vehicle door may be provided with an inside handle and a grip that are individually disposed on a door trim. The inside handle may lock or unlock the latch mechanism, and the grip may allow a user to grip for pushing or pulling.

As the user rotates the inside handle in one direction thereof, the latch mechanism may be unlocked, and then the user may grip and push the grip to thereby open the vehicle door. As the user rotates the inside handle in the other direction thereof, the latch mechanism may be locked, and then the user may grip and pull the grip to thereby close the vehicle door.

As the inside handle and the grip are individually disposed, freedom of design with respect to the door trim of the vehicle door may be restricted, and it would be difficult to provide a luxury image of the vehicle and meet consumer needs.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an inside handle with integrated grip, in which a grip and an inside handle are integrated to improve ease of use, freedom of design, aesthetic appearance, and the like.

According to various aspects of the present invention, an inside handle with integrated grip may include a grip handle rotatably mounted on a door trim of a vehicle door and configured for being gripped, and a cable connector assembly having a lever which is pivotable by a rotation of the grip handle, wherein the lever moves a cable assembly connected to a latch mechanism of the vehicle door to lock or unlock the latch mechanism of the vehicle door.

The grip handle may include a first grip member having a shaft, and a second grip member having an operation portion abutting the lever.

A torsion spring may be disposed around the shaft, and the grip handle may return to its original position by the torsion spring.

The cable assembly may include a sheath, and a cable wire disposed to be movable in the sheath, and an end portion of the cable wire may be connected to the lever.

The end portion of the cable wire may be fixed to a cable guide member, and the cable guide member may be detachably coupled to the lever.

The cable connector assembly may include a first cage in which the lever is pivotally mounted, and a second cage to which the cable assembly is connected.

The lever may be pivotally mounted in the first cage through a pivot pin, a torsion spring may be disposed around the pivot pin, and the lever may return to its original position by the torsion spring.

The second cage may be detachably coupled to the first cage.

The second cage may have a guide slot for guiding movement of the cable guide member.

The sheath of the cable assembly may be coupled to the second cage through a snap-fit fastener.

The grip handle may be rotatably mounted on the door trim of the vehicle door through at least one mounting trim.

The cable connector assembly may be mounted on the mounting trim.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a structure in which an inside handle with integrated grip according to an exemplary embodiment of the present invention is mounted on a vehicle door,

FIG. 2 illustrates a perspective view of an inside handle with integrated grip according to an exemplary embodiment of the present invention,

FIG. 3 illustrates a view in the direction of arrow A in FIG. 2,

FIG. 4 illustrates a view in the direction of arrow B in FIG. 3,

FIG. 5 illustrates an exploded perspective view of a grip handle of an inside handle with integrated grip according to an exemplary embodiment of the present invention,

FIG. 6 illustrates a structure in which a grip handle of an inside handle with integrated grip according to an exemplary embodiment of the present invention is mounted on an upper mounting trim,

FIG. 7 illustrates a structure in which a grip handle and a cable connector assembly of an inside handle with integrated grip according to an exemplary embodiment of the present invention are mounted on an upper mounting trim,

FIG. 8 illustrates a structure in which a lever and a first cage of a cable connector assembly are connected to a grip handle of an inside handle with integrated grip according to an exemplary embodiment of the present invention,

FIG. 9 illustrates a perspective view of a structure in which a lever and a first cage of an inside handle with integrated grip according to an exemplary embodiment of the present invention are coupled,

FIG. 10 illustrates an exploded perspective view of the lever and the first cage in FIG. 9,

FIG. 11 illustrates a view in the direction of arrow C in FIG. 9,

FIG. 12 illustrates an exploded perspective view of the lever and the first cage in FIG. 11,

FIG. 13 illustrates a structure in which a first cage and a second cage in a cable connector assembly of an inside handle with integrated grip according to an exemplary embodiment of the present invention are detached,

FIG. 14 illustrates a structure in which a cable assembly is connected to a second cage of an inside handle with integrated grip according to an exemplary embodiment of the present invention,

FIG. 15 illustrates an exploded perspective view of the second cage and the cable assembly in FIG. 14, and

FIG. 16 illustrates a view in the direction of arrow D in FIG. 7, a structure in which an operation portion of a grip handle, a lever, and a cable assembly are connected.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, various exemplary embodiments of the present invention will be described in detail with reference to the accompanying drawings. In the drawings, the same reference numerals will be used throughout to designate the same or equivalent elements. In addition, a detailed description of well-known techniques associated with the present invention will be ruled out in order not to unnecessarily obscure the gist of the present invention.

Terms such as first, second, A, B, (a), and (b) may be used to describe the elements in exemplary embodiments of the present invention. The. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

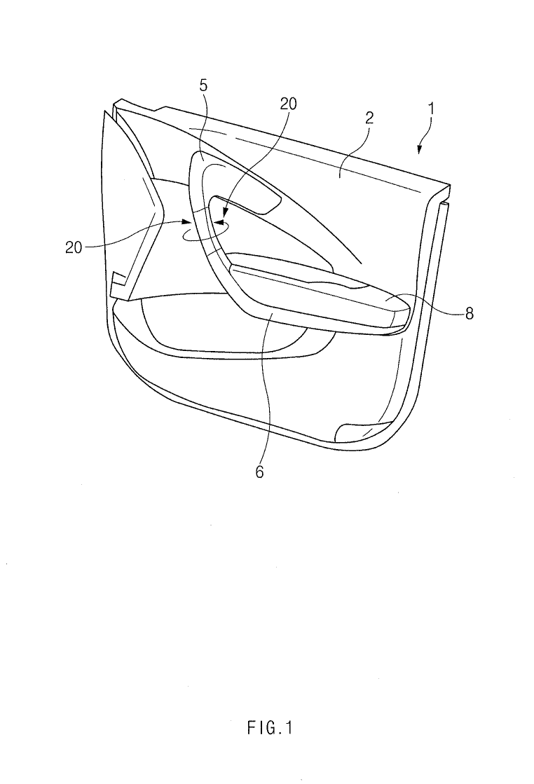

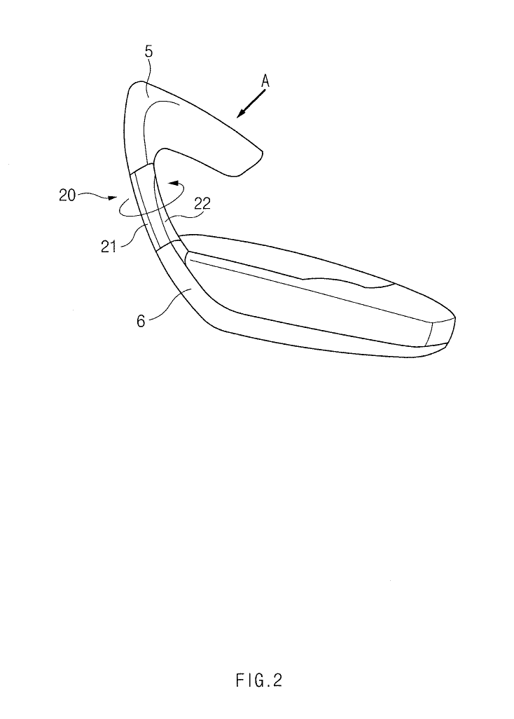

Referring to FIG. 1 and FIG. 2, an inside handle with integrated grip, according to an exemplary embodiment of the present invention, may include a grip handle 20, and the grip handle 20 may be mounted on a door trim 2 of a vehicle door 1 through an upper mounting trim 5 and a lower mounting trim 6.

The lower mounting trim 6 may be bent, and the lower mounting trim 6 may be coupled to a door armrest 8 of the vehicle door 1. The upper mounting trim 5 may be bent, and the upper mounting trim 5 may be coupled to an upper portion of the door trim 2.

The contour and surface of the grip handle 20 may be formed to facilitate a user's gripping. The grip handle 20 may be rotatably mounted between the upper mounting trim 5 and the lower mounting trim 6.

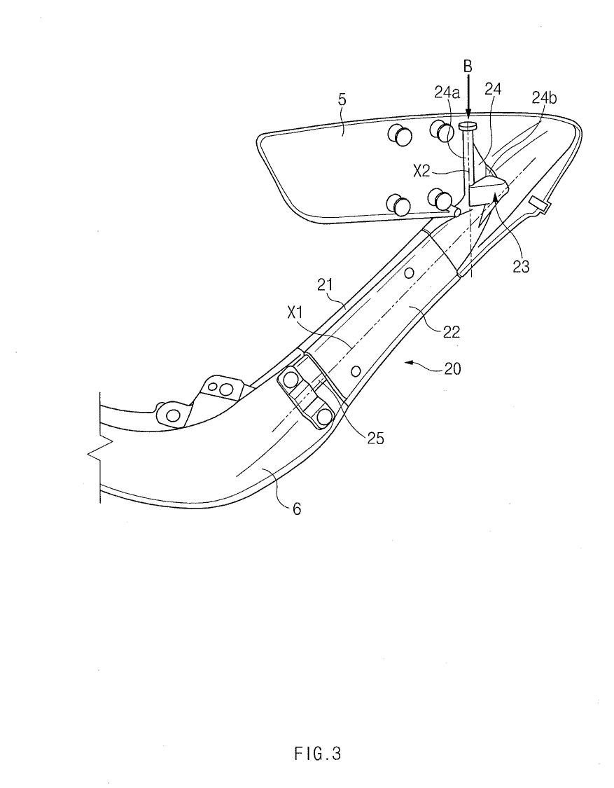

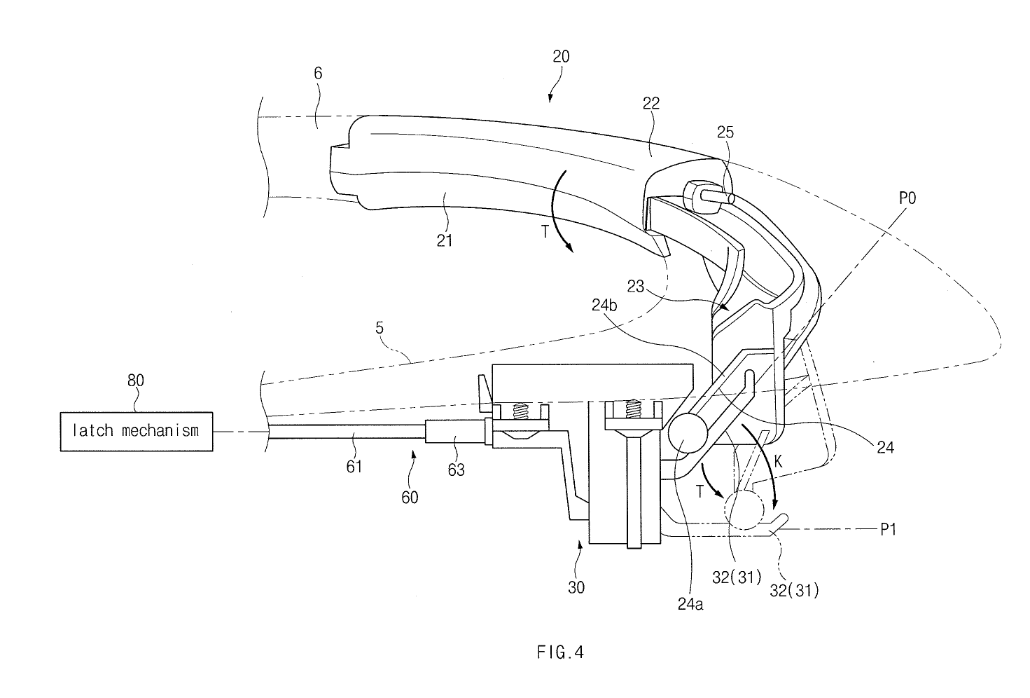

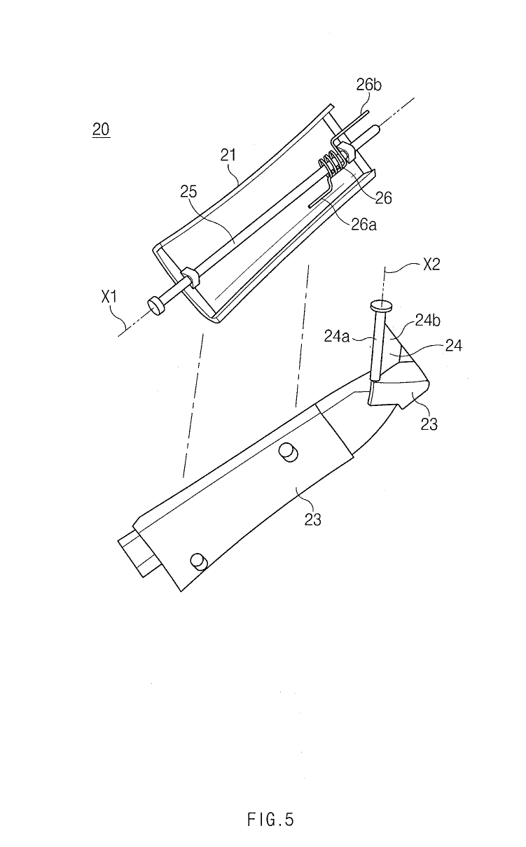

As illustrated in FIG. 3, FIG. 4, and FIG. 5, the grip handle 20 may include a first grip member 21 and a second grip member 22 detachably coupled to the first grip member 21. A grip cover may be attached to the external surfaces of the first grip member 21 and the second grip member 22 to facilitate gripping. As the first grip member 21 and the second grip member 22 are assembled, the appearance thereof may be improved.

As illustrated in FIG. 2, the first grip member 21 may be disposed to face the internal of the vehicle, and the second grip member 22 may be disposed to face the vehicle door.

As illustrated in FIG. 5, the first grip member 21 may have a shaft 25, and the shaft 25 may be coupled to the first grip member 21. For example, the shaft 25 may be detachably coupled to the first grip member 21. As another example, the shaft 25 may be integrated with the first grip member 21 by casting or molding.

One end portion of the shaft 25 may be rotatably supported with respect to the upper mounting trim 5, and the other end portion of the shaft 25 may be rotatably supported with respect to the lower mounting trim 6. The grip handle 20 may be rotatable about an axis X1 of the shaft 25.

A torsion spring 26 may be disposed around the shaft 25, and the grip handle 20 may return to its original position by the torsion spring 26. A first leg 26a of the torsion spring 26 may be supported with respect to the first grip member 21, and a second leg 26b of the torsion spring 26 may be supported with respect to the upper mounting trim 5.

The second grip member 22 may be coupled to the first grip member 21 through fasteners or the like. The second grip member 22 may have an operation portion 23. The operation portion 23 may extend from one end portion of the second grip member 22. The operation portion 23 may be disposed in the upper mounting trim 5, and the operation portion 23 may be bent such that it may correspond to the bent structure of the upper mounting trim 5. For example, the operation portion 23 may be bent at a predetermined angle with respect to the axis X1 of the shaft 25.

The operation portion 23 may have an operation surface 24, and the operation surface 24 may be formed by a support protrusion 24a protruding from the operation portion 23 and a support wall 24b. An axis X2 of the support protrusion 24a may intersect with the axis X1 of the shaft 25 at a predetermined angle. The operation surface 24 of the operation portion 23 may abut a lever 31 of a cable connector assembly 30 to be described later. As the grip handle 20 rotates, the operation surface 24 may pivot the lever 31 of the cable connector assembly 30.

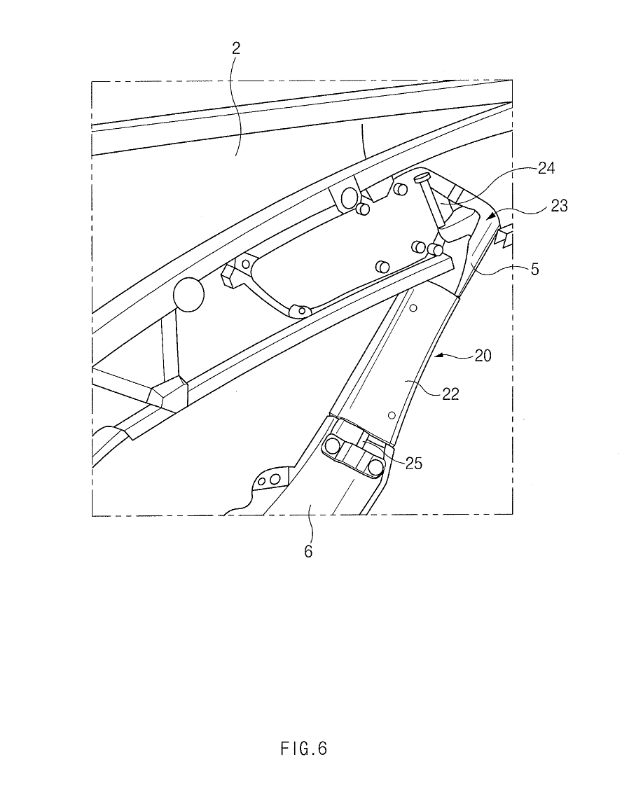

As illustrated in FIG. 6, the grip handle 20 may be mounted on the door trim 2 of the vehicle door 1 through the upper mounting trim 5 and the lower mounting trim 6.

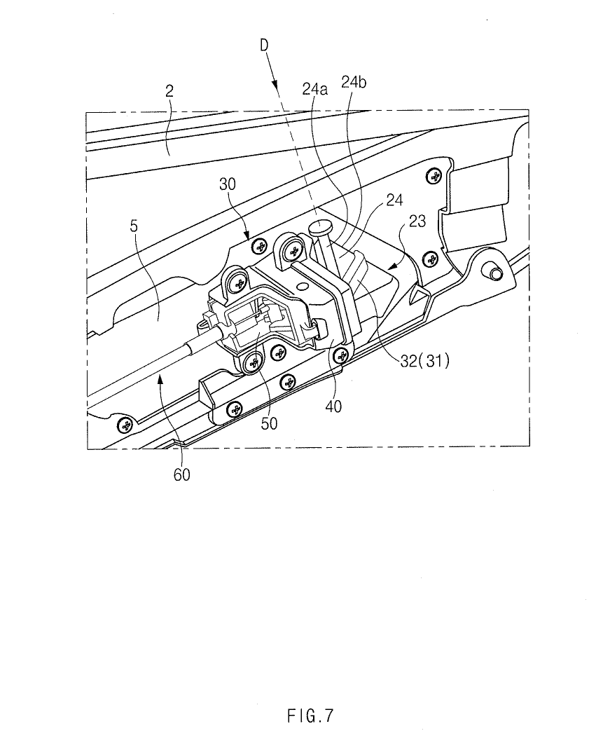

As illustrated in FIGS. 4 and 7, the cable connector assembly 30 may be connected to the grip handle 20. As illustrated in FIG. 4, a cable assembly 60 may be connected between the cable connector assembly 30 and a latch mechanism 80 of the vehicle door 1.

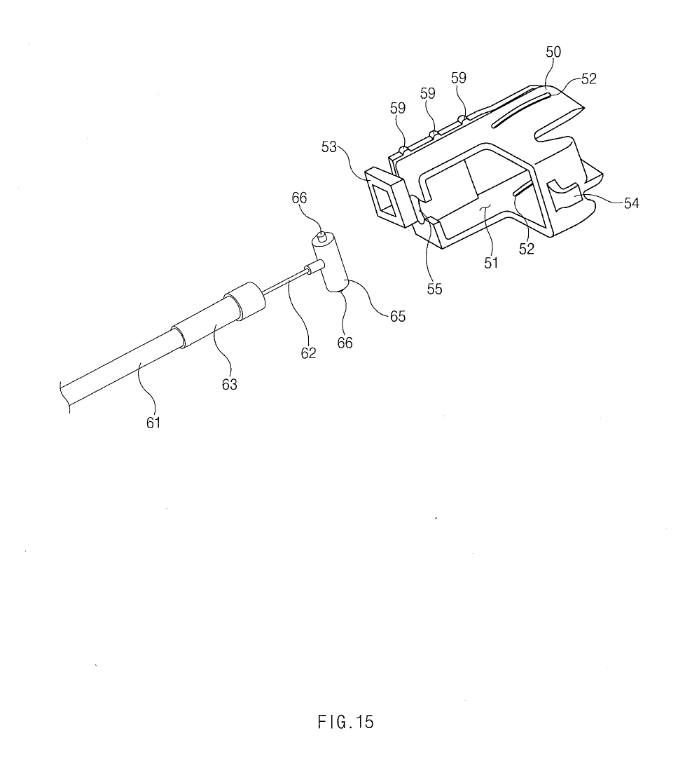

Referring to FIG. 15, the cable assembly 60 may include a sheath 61, and a cable wire 62 disposed to be movable in the sheath 61. One end portion of the cable wire 62 may be fixed to a cable guide member 65, and the cable guide member 65 may be detachably coupled to the lever 31. Thus, the cable wire 62 may be moved by the pivoting of the lever 31. A snap-fit fastener 63 may be fixed to an end portion of the sheath 61. The cable wire 62 and the sheath 61 may include a flexible material.

The cable connector assembly 30 may move the cable assembly 60 by the operation of the grip handle 20, locking or unlocking the latch mechanism 80 of the vehicle door.

The cable connector assembly 30 may be mounted on the upper mounting trim 5 as illustrated in FIG. 7.

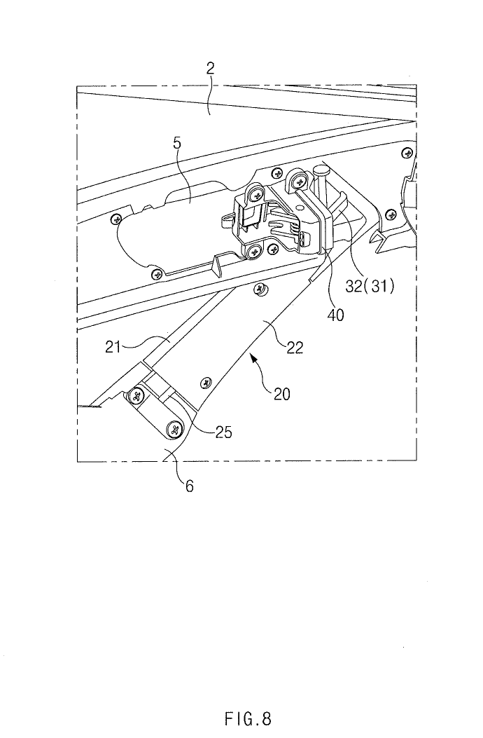

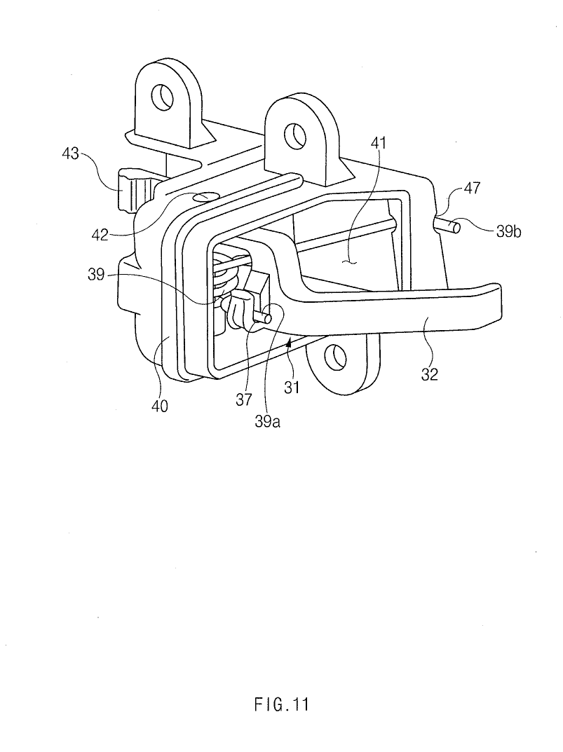

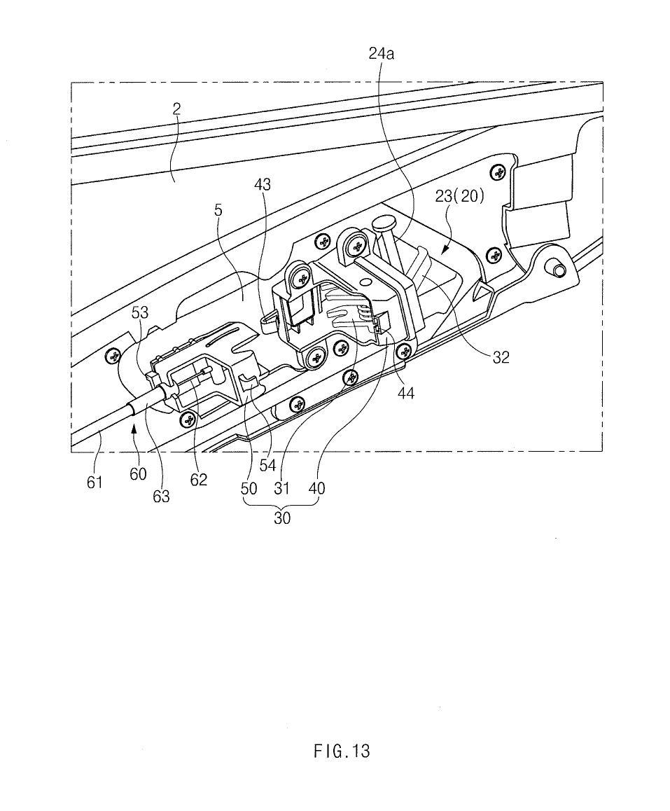

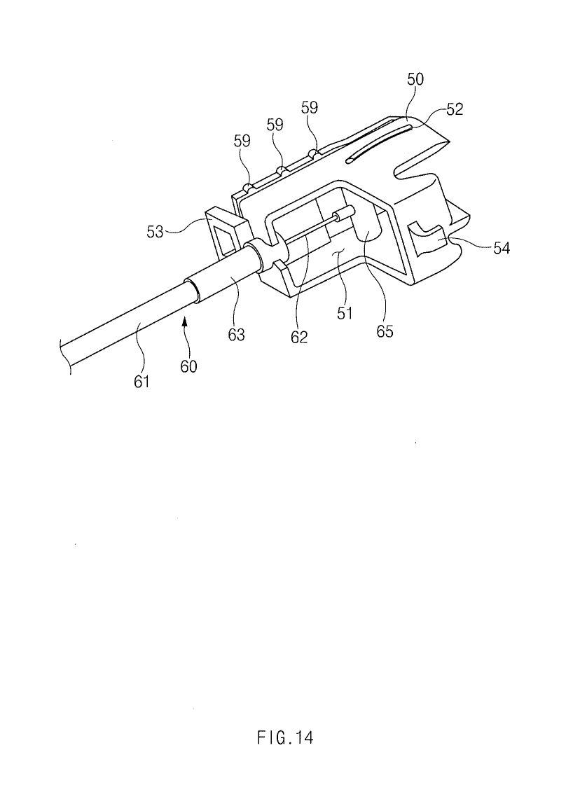

The cable connector assembly 30 may include, as illustrated in FIGS. 8 to 14, the lever 31 abutting the operation portion 23 of the grip handle 20, a first cage 40 in which the lever 31 is pivotally mounted, and a second cage 50 to which the cable assembly 60 is connected.

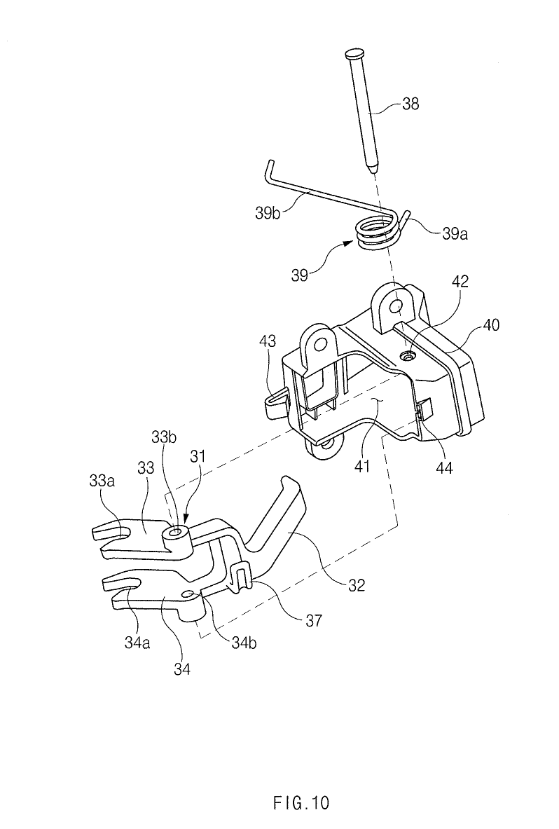

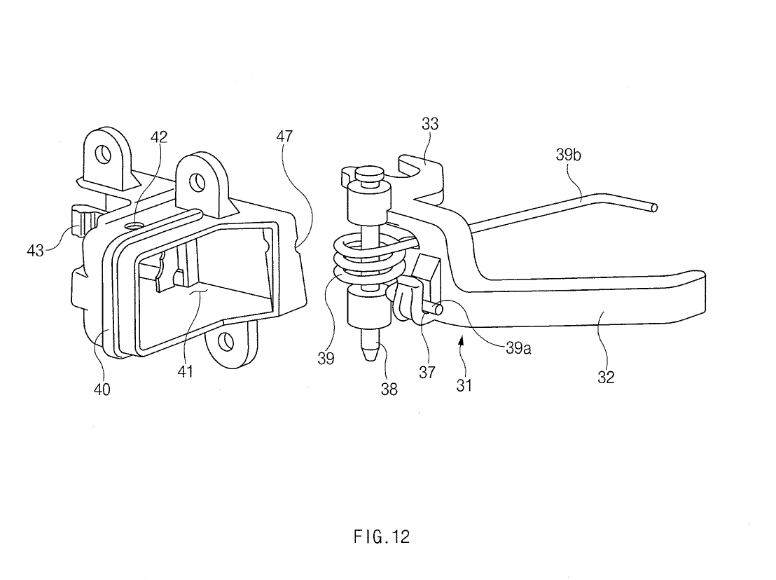

The lever 31 may be pivotally mounted in the first cage 40 through a pivot pin 38 as illustrated in FIGS. 10 and 12.

The lever 31 may have a lever body 32 abutting the operation portion 23 of the grip handle 20, and two legs 33 and 34 extending from the lever body 32.

The lever body 32 may abut the operation surface 24 of the operation portion 23.

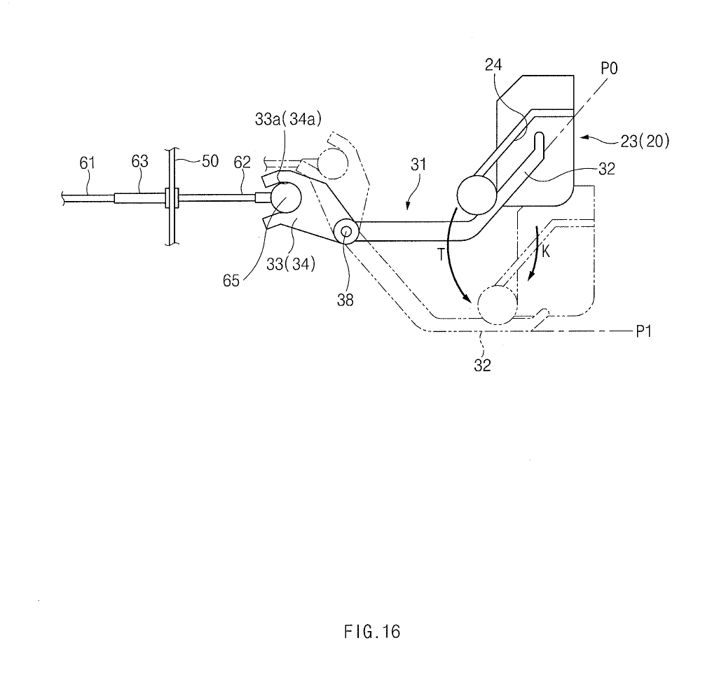

As the grip handle 20 rotates, the lever body 32 may pivot on the pivot pin 38. The lever body 32 may pivot by the rotation of the grip handle 20 so that the lever 31 may move between a pulling position (see “P1” in FIGS. 4 and 16) by pulling the cable wire 62 of the cable assembly 60 and a return position (see “P0” in FIGS. 4 and 16) by returning the cable wire 62 of the cable assembly 60 to its original position.

When the lever 31 moves to the pulling position (see “P1” in FIGS. 4 and 16), the cable wire 62 may be pulled. By pulling the cable wire 62, the latch mechanism of the vehicle door 1 may be unlocked. When the lever 31 moves to the return position (see “P0” in FIGS. 4 and 16), the cable wire 62 may return to its original position. By returning the cable wire 62 to its original position, the latch mechanism of the vehicle door 1 may be locked.

The two legs 33 and 34 may be spaced from each other, and the legs 33 and 34 may have engaging grooves 33a and 34a, respectively. Both end portions of the cable guide member 65 may be press-fit into the engaging grooves 33a and 34a of the legs 33 and 34.

The legs 33 and 34 may have respective pivot holes 33b and 34b through which the pivot pin 38 passes, and the pivot pin 38 may allow the lever 31 to be pivotally mounted in the first cage 40.

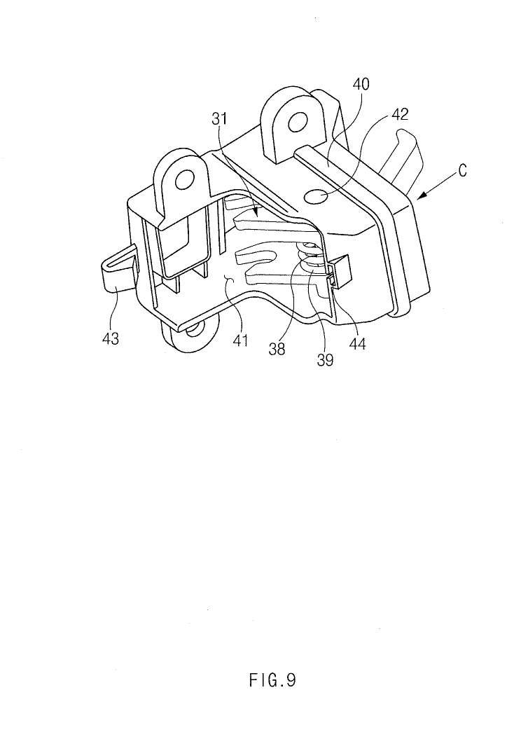

The first cage 40 may be fixed to an internal surface of the upper mounting trim 5 through a plurality of fasteners, as illustrated in FIG. 8. The first cage 40 may have a cavity 41 in which the lever 31 is received, as illustrated in FIGS. 9 to 12.

The first cage 40 may have pivot holes 42 through which the pivot pin 38 passes, and the pivot holes 42 of the first cage 40 may be aligned with the pivot holes 33b and 34b of the legs 33 and 34. As the pivot pin 38 passes through the pivot holes 42 of the first cage 40 and the pivot holes 33b and 34b of the legs 33 and 34, the lever 31 may be pivotally mounted in the first cage 40.

A torsion spring 39 may be disposed around the pivot pin 38, and the lever 31 may return to its original position by the torsion spring 39. A first leg 39a of the torsion spring 39 may be supported with respect to the lever 31, and a second leg 39b of the torsion spring 39 may be supported with respect to the first cage 40. The lever 31 may have an engaging groove 37 with which the first leg 39a of the torsion spring 39 is engaged, and the first cage 40 may have an engaging groove 47 with which the second leg 39b of the torsion spring 39 is engaged.

The second cage 50 may have an internal space 51 in which one end portion of the cable assembly 60 and the legs 33 and 34 of the lever 31 are received.

The second cage 50 may have an engaging cavity 55 with which the snap-fit fastener 63 of the cable assembly 60 is engaged, and the sheath 61 of the cable assembly 60 may be supported with respect to the second cage 50 through the snap-fit fastener 63.

As the cable guide member 65 of the cable assembly 60 is engaged with the engaging grooves 33a and 34a of the lever 31, the cable wire 62 of the cable assembly 60 may be moved by the pivoting of the lever 31. A protrusion 66 may protrude from each end portion of the cable guide member 65.

A pair of guide slots 52 may be formed in respective sidewalls of the second cage 50. The protrusions 66 of the cable guide member 65 may be guided along the guide slots 52, respectively. Each guide slot 52 may be formed in an arc shape corresponding to a pivot trajectory of the lever 31.

The second cage 50 may be detachably snap-fit with respect to the first cage 40. The first cage 40 may have a first hook 43, and the second cage 50 may have a second hook 53 which is snap-fit to the first hook 43 of the first cage 40. Furthermore, the first cage 40 may have an engaging groove 44, and the second cage 50 may have an engaging hook 54 which is detachably snap-fit to the engaging groove 44 of the first cage 40.

The second cage 50 may have a plurality of protrusions 59 on an external surface thereof. As the protrusions 59 of the second cage 50 are brought in close contact with the internal surface of the first cage 40, the second cage 50 may be securely coupled to the first cage 40.

Referring to FIG. 16, to open the vehicle door, when the user grips and rotates the grip handle 20 in one direction (see a direction indicated by arrow T in FIG. 4), the operation portion 23 of the grip handle 20 may also rotate, and the lever body 32 of the lever 31 abutting the operation surface 24 of the operation portion 23 may be pivoted on the pivot pin 38 (see a direction indicated by arrow K in FIGS. 4 and 16), and thus the lever body 32 may move to the pulling position P1 for pulling the cable wire 62 of the cable assembly 60. As the cable wire 62 is pulled, the latch mechanism of the vehicle door 1 may be unlocked. In the present state, as the user pushes the grip handle 20 toward the outside of the vehicle, the vehicle door 1 may be opened.

When the user releases the grip handle 20, the grip handle 20 may return to its original position by the torsion spring 26, and thus the lever 31 may move to the return position P0 by the torsion spring 39. As the cable wire 62 returns to its original position, the latch mechanism of the vehicle door 1 may be locked.

As set forth above, according to exemplary embodiments of the present invention, by integrating the function of a grip and the function of an inside handle into the grip handle, an installation space of the inside handle with integrated grip on the vehicle door may significantly be reduced, and thus freedom of design may be increased.

Furthermore, since a parting line of the handle is eliminated, the aesthetic appearance thereof may significantly be improved. By improving operability, ease of use may be improved. Furthermore, the inside handle with integrated grip may provide improved grip feeling, allowing the user to feel more comfortable when operating the handle.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An inside handle with an integrated grip, comprising:
a grip handle rotatably mounted on a door trim of a vehicle door and configured for being gripped; and
a cable connector assembly having a lever which is pivotable by a rotation of the grip handle,
wherein the lever moves a cable assembly engaged to the cable connector assembly and connected to a latch mechanism of the vehicle door to lock or unlock the latch mechanism of the vehicle door.

2. The inside handle with the integrated grip according to claim 1, wherein the grip handle includes a first grip member and a second grip member detachably coupled to the first grip member.

3. The inside handle with the integrated grip according to claim 1, wherein the grip handle includes a first grip member having a shaft, and a second grip member having an operation portion abutting the lever.

4. The inside handle with the integrated grip according to claim 3, wherein a first end of the shaft is rotatably supported with respect to an upper mounting trim and a second end of the shaft is rotatably supported with respect to a lower mounting trim.

5. The inside handle with the integrated grip according to claim 3, wherein the operation portion of the second grip member includes an operation surface formed by a support protrusion protruding from the operation portion and a support wall, and wherein an operation surface of the operation portion abuts the lever of the cable connector assembly.

6. The inside handle with the integrated grip according to claim 3, wherein a torsion elastic member is disposed around the shaft, and
the grip handle returns to an original position thereof by the torsion elastic member.

7. The inside handle with the integrated grip according to claim 1, wherein the cable assembly includes a sheath, and a cable wire disposed to be movable in the sheath, and
an end portion of the cable wire is connected to the lever.

8. The inside handle with the integrated grip according to claim 7, wherein the end portion of the cable wire is fixed to a cable guide member, and
the cable guide member is detachably coupled to the lever.

9. The inside handle with the integrated grip according to claim 8, wherein the cable connector assembly includes a first cage in which the lever is pivotally mounted, and a second cage to which the cable assembly is connected.

10. The inside handle with the integrated grip according to claim 9, wherein the lever is pivotally mounted in the first cage through a pivot pin,
a torsion elastic member is disposed around the pivot pin, and
the lever is configured to return to an original position thereof by the torsion elastic member.

11. The inside handle with the integrated grip according to claim 9, wherein the second cage is detachably coupled to the first cage.

12. The inside handle with the integrated grip according to claim 11, wherein the cable guide member is pivotally engaged with an engaging groove of the lever.

13. The inside handle with the integrated grip according to claim 11, wherein the second cage has a guide slot for guiding a movement of the cable guide member.

14. The inside handle with the integrated grip according to claim 13, wherein the cable wire includes a protrusion slidably coupled to the guide slot of the second cage.

15. The inside handle with the integrated grip according to claim 9, wherein the sheath of the cable assembly is coupled to the second cage through a snap-fit fastener.

16. The inside handle with the integrated grip according to claim 1, wherein the grip handle is rotatably mounted on the door trim of the vehicle door through a mounting trim.

17. The inside handle with the integrated grip according to claim 17, wherein the cable connector assembly is mounted on the mounting trim.
